(19) United States
(12) Patent Application Publication
(10) Pub. No.: US 2018/0031916 A1
(43) Pub. Date: Feb. 1, 2018

(54) LIQUID CRYSTAL TELEVISION DEVICE AND SYSTEM

(71) Applicant: Shenzhen China Star Optoelectronics Technology Co., Ltd., Shenzhen, Guangdong (CN)

(72) Inventors: Yu-yeh CHEN, Shenzhen, Guangdong (CN); Yin-hung CHEN, Shenzhen, Guangdong (CN); Yu WU, Shenzhen, Guangdong (CN)

(73) Assignee: Shenzhen China Star Optoelectronics Technology Co., Ltd., Shenzhen, Guangdong (CN)

(21) Appl. No.: 14/908,509

(22) PCT Filed: Dec. 25, 2015
(86) PCT No.: PCT/CN2015/098967

§ 371 Date: Jan. 28, 2016

(30) Foreign Application Priority Data
Dec. 2, 2015 (CN) 201510872536.7

(51) Int. Cl. G02F 1/1335; G09G 3/34; G09G 3/36

(52) U.S. Cl. CPC G02F 1/133602; G09G 3/36; G09G 3/3406

(57) ABSTRACT

The present disclosure discloses an LCD device and system. The LCD device includes an LCD body and a T-CON control circuit board. The T-CON control circuit board connects to the LCD body and connects to the external content providing apparatus to convert a video signal receiving from the content providing apparatus to a signal to be displayed for the LCD body, and drives the LCD body to display images according to the signal to be displayed. Further, the LCD device does not have an SOC main control circuit board. With the aforementioned ways, the present disclosure can lower the cost of the TV and is beneficial to simplify the inner structure of the TV device.

### FIELD OF THE INVENTION

The present invention relates to display technical field, especially to a liquid crystal television (TV) device and system

### BACKGROUND OF THE INVENTION

LCD have advantages of thin body, electricity-saving and power consumption, image steady, no irradiation and so on so that are favored by the users.

With reference to FIG. 1, a conventional LCD 10 usually comprises a liquid crystal display (LCD) body 11, a timer control register (T-CON) control circuit board 12 and a System-On-a-Chip (SOC) main control circuit board 13 and so on. The SOC main control circuit board 13 is mainly used to receive the video signal from the cable digital TV set-top box and then to acquire the display signal for the LCD body by processing the video signal. The T-CON control circuit board 12 is used to drive the LCD body 11 to display according to the display signal transmitted from the SOC main control circuit board 13 so that the images are displayed.

Further, the SOC main control circuit board 13 has various kinds of connectors, besides for receiving the void signal from the digital TV set-top box and also for preforming various operation to the LCD through a SOC chip own system and APP (a third party application, Application). Also, the SOC main control circuit board 13 can also receive the video signal transmitted from a smart set-top box 14 (such as Baidu box, Tmall box, Mi box) so that the TV can directly play the video of the smart set-top box. The smart set-top box 14 usually has a power connector to connect to the external power such as 220V household power to be supplied power by the external power.

Presently, the functions of the smart set-top box 14 are stronger and stronger. It not only has a great amount of videos but also can access internet wirelessly, can install various of APPs by itself and has the same function with the conventional digital TV set-top box to broadcast TV channels. Those functions are performed to play by transmitting to the SOC main control circuit board 13. However, when the SOC main control circuit board 13 connects to the smart set-top box 14, it only plays the role to convert the format of the signal and its own function is weakened and ignored. As a result, the most circuits on the SOC main control circuit board 13 are at idle status to cause the resources waste so that is harmful to lower the cost and the complexity of the circuit.

### SUMMARY OF THE INVENTION

The main technical problem to be solved by the present invention is to provide to lower the cost of the TV and to be beneficial to simplify the internal structure of the TV device.

To solve the aforementioned technical problem, the present invention provides a technical way to provide a LCD device comprising a LCD body, a T-CON control circuit board and an adapting board, wherein: the T-CON control circuit board connects to the LCD body and is adapted for connecting to an external content providing apparatus; the T-CON control circuit board comprises a converting circuit, a T-CON control circuit and a first connector; the first connector is adapted for connecting to the content providing apparatus; the converting circuit converts a video signal receiving through the first connector from the content providing apparatus to a signal to be displayed for the LCD body, and transmits the signal to be displayed to the T-CON control circuit; the T-CON control circuit drives the LCD body to display images according to the signal to be displayed; the LCD device does not have an SOC main control circuit board; and the content providing apparatus is a smart set-top box; the first connector is adapted for connecting a high definition multimedia interface (HDMI) of the content providing apparatus; and the first connector connects the converting board to adapted for connecting the content providing apparatus through the converting board.

Further, it further comprises a power circuit board, wherein the power circuit board comprises a power circuit and a transformer circuit; the power circuit connects to the transformer circuit; the transformer circuit connects to the T-CON control circuit to supply power to the T-CON control circuit; the transformer circuit also connects to the first connector to adapted for supplying power to the content providing apparatus through the first connector; the transformer circuit also connects to a backlight driving circuit of the LCD body to supply a driving voltage to the backlight driving circuit; and wherein the first connector comprises: a working voltage output lead adapted to output a desired working voltage to the content providing apparatus for working normally; a standby voltage output lead adapted to output a desired standby voltage to the content providing apparatus for standby; and an enable signal lead adapted to receive an enable signal sending from the content providing apparatus, transmitting the enable signal to the transformer circuit so that the transformer circuit provides driving voltage to the backlight driving circuit of the LCD body.

Further, it further comprises at least two signal transmitting circuit boards, wherein the T-CON control circuit respectively connects to the at least two signal transmitting circuit boards; the T-CON control circuit generates desired control signals respectively for gate driving circuits and data driving circuits according to the signal to be displayed and correspondingly transmits the control signals to the gate driving circuits and the data driving circuits on the LCD body through the at least two signal transmitting circuit boards to control the gate driving circuits and the data driving circuits to drive the LCD body to display images.

Further, at least one of the signal transmitting circuit boards and the T-CON control circuit board are assembled on the same circuit board.

To solve the aforementioned technical problem, the present invention provides a technical way to provide an LCD device comprising an LCD body and a T-CON control circuit board, wherein: the T-CON control circuit board connects to the LCD body and is adapted for connecting to an external content providing apparatus to convert a video signal receiving from the content providing apparatus to a signal to be displayed for the LCD body, drives the LCD body to display images according to the signal to be displayed; and the LCD device does not have an SOC main control circuit board.

Further, the T-CON control circuit board comprises a converting circuit, a T-CON control circuit and a first connector; the first connector is adapted for connecting to the content providing apparatus; the converting circuit converts the video signal receiving through the first connector from the content providing apparatus to the signal to be displayed for the LCD body, and transmits the signal to be displayed to the T-CON control circuit; and the T-CON control circuit drives the LCD body to display images according to the signal to be displayed.

Further, the content providing apparatus is a smart set-top box; the first connector is adapted for connecting an HDMI of the content providing apparatus.

Further, it further comprises a power circuit board, wherein the power circuit board comprises a power circuit and a transformer circuit; the power circuit connects to the transformer circuit; the transformer circuit connects to the T-CON control circuit to supply power to the T-CON control circuit; the transformer circuit also connects to the first connector to adapted for supplying power to the content providing apparatus through the first connector; the transformer circuit also connects to a backlight driving circuit of the LCD body to supply a driving voltage to the backlight driving circuit; and wherein the first connector comprises: a working voltage output lead adapted to output a desired working voltage to the content providing apparatus for working normally; a standby voltage output lead adapted to output a desired standby voltage to the content providing apparatus for standby; and an enable signal lead adapted to receive an enable signal sending from the content providing apparatus, transmitting the enable signal to the transformer circuit so that the transformer circuit provides driving voltage to the backlight driving circuit of the LCD body.

Further, it further comprises an adapting board, wherein the first connector connects to the adapting board to adapted for connecting to the content providing apparatus through the adapting board.

Further, it further comprises at least two signal transmitting circuit boards, wherein the T-CON control circuit respectively connects to the at least two signal transmitting circuit boards; the T-CON control circuit generates desired control signals respectively for gate driving circuits and data driving circuits according to the signal to be displayed and correspondingly transmits the control signals to the gate driving circuits and the data driving circuits on the LCD body through the at least two signal transmitting circuit boards to control the gate driving circuits and the data driving circuits to drive the LCD body to display images.

Further, at least one of the signal transmitting circuit boards and the T-CON control circuit board are assembled on the same circuit board.

To solve the aforementioned technical problem, the present invention provides a technical way to provide an LCD system comprises an LCD body and a T-CON control circuit board; the T-CON control circuit board connects to the LCD body and connects to the external content providing apparatus to convert a video signal receiving from the content providing apparatus to a signal to be displayed for the LCD body, and drives the LCD body to display images according to the signal to be displayed; and the LCD device does not have an SOC main control circuit board.

Further, the T-CON control circuit board comprises a converting circuit, a T-CON control circuit and a first connector; the first connector is adapted for connecting to the content providing apparatus; the converting circuit converts the video signal receiving through the first connector from the content providing apparatus to the signal to be displayed for the LCD body, and transmits the signal to be displayed to the T-CON control circuit; and the T-CON control circuit drives the LCD body to display images according to the signal to be displayed.

Further, the content providing apparatus is a smart set-top box; the first connector is adapted for connecting an HDMI of the content providing apparatus; the LCD system further comprises a power circuit board, wherein the power circuit board comprises a power circuit and a transformer circuit; the power circuit connects to the transformer circuit; the transformer circuit connects to the T-CON control circuit to supply power to the T-CON control circuit; the transformer circuit also connects to the first connector to supply power to the content providing apparatus through the first connector; the transformer circuit also connects to a backlight driving circuit of the LCD body to supply a driving voltage to the backlight driving circuit; and wherein the first connector comprises: a working voltage output lead to output a desired working voltage to the content providing apparatus for working normally; a standby voltage output lead to output a desired standby voltage to the content providing apparatus for standby; and an enable signal lead to receive an enable signal sending from the content providing apparatus, transmitting the enable signal to the transformer circuit so that the transformer circuit provides driving voltage to the backlight driving circuit of the LCD body.

Further, it further comprises an adapting board, wherein the first connector connects to the adapting board to connect to the content providing apparatus through the adapting board.

Further, it further comprises at least two signal transmitting circuit boards, wherein the T-CON control circuit respectively connects to the at least two signal transmitting circuit boards; the T-CON control circuit generates desired control signals respectively for gate driving circuits and data driving circuits according to the signal to be displayed and correspondingly transmits the control signals to the gate driving circuits and the data driving circuits on the LCD body through the at least two signal transmitting circuit boards to control the gate driving circuits and the data driving circuits to drive the LCD body to display images.

Further, at least one of the signal transmitting circuit boards and the T-CON control circuit board are assembled on the same circuit board.

The beneficial effect is: comparing to the prior art, in the present invention, the LCD device does not have the SOC main control circuit board. Through the T-CON control circuit board connecting to the content providing apparatus to convert a video signal receiving from the content providing apparatus to a signal to be displayed for the LCD body, the LCD body to display images according to the signal to be displayed is achieved. Since achieving the display of the TV device does not need the SOC main control circuit board, the SOC main control circuit board is deleted to eliminate the low utilization module. Then the manufacturing cost is lower, the TV system is optimized, and the internal structure of the TV device is also simplified.

### BRIEF DESCRIPTION OF THE DRAWINGS

FIG. 1 is an illustrative view of the structure of a conventional LCD;

FIG. 2 is an illustrative view of one embodiment of the structure of an LCD device in accordance with the present invention;

FIG. 3 is an illustrative view of another embodiment of the structure of an LCD device in accordance with the present invention;

FIG. 4 is an illustrative view of still another embodiment of the structure of an LCD device in accordance with the present invention;

FIG. 5 is an illustrative view of still another embodiment of the structure of an LCD device in accordance with the present invention; and

FIG. 6 is an illustrative view of one embodiment of the structure of an LCD system in accordance with the present invention.

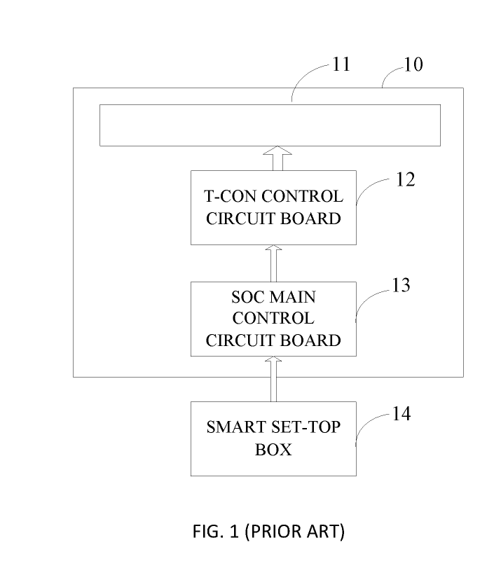

### DETAILED DESCRIPTION OF THE PREFERRED EMBODIMENTS

In conjunction with the accompanying drawings and the following embodiments of the present invention are described in detail.

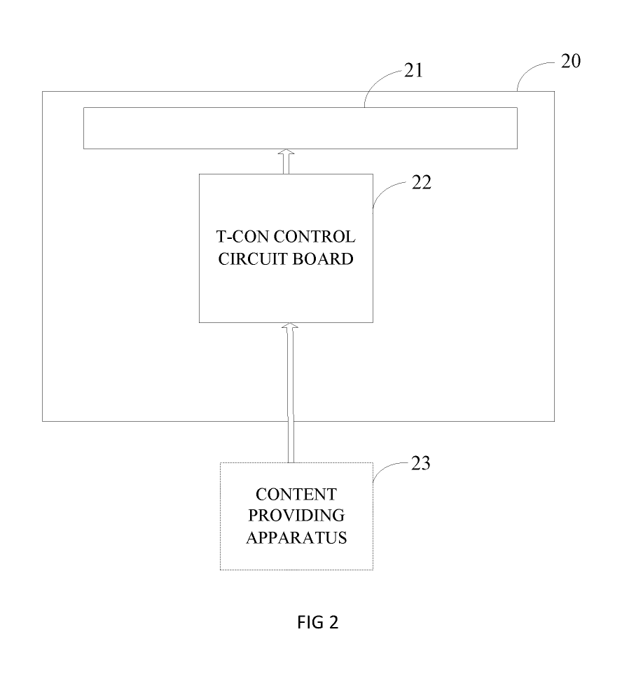

With reference to FIG. 2, in one embodiment of an LCD device in accordance with the present invention, the LCD device 20 comprises an LCD body 21 and a T-CON control circuit board 22. Further, the LCD device 20 does not have an SOC main control circuit board.

The T-CON control circuit board 22 connects to the LCD body and is used to connect to an external content providing apparatus 23 to convert the video signal from the content providing apparatus 23 to a signal to be displayed for the LCD body 21 and drives the LCD body to display images according to the signal to be displayed. Thus, the LCD body 21 to display is achieved.

In this embodiment, with the signal converting function added in the T-CON control circuit board to convert the video content from the content providing apparatus 24 to the display signal for the LCD body 21. Thus, there is no need to additionally mount an SOC main control circuit board and the broadcast function can still be achieved so that the SOC main control circuit board component can be eliminated from the LCD device 20 to be beneficial to lower the cost. Besides, the circuit to achieve the signal converting function is only needed to be added in the T-CON control circuit board. The complexity of the circuit is far less than the complexity of the SOC main control circuit board to simplify the structure. Therefore, with the signal converting function is assembled in the T-CON control circuit board 22 but not additionally add a circuit board for converting signal to further simplify the structure and to be beneficial to reduce the space occupied by the circuit board, and is beneficial to the development of the LCD device to be light and thin.

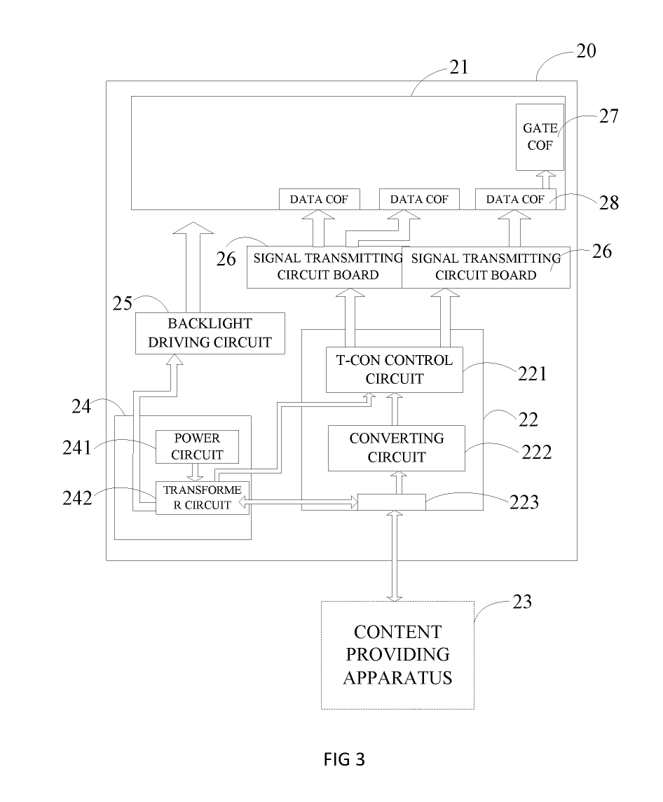

With reference to FIG. 3, FIG. 3 is an illustrative view of another embodiment of the structure of an LCD device in accordance with the present invention, wherein the components with the same referenced number have the same function. Further, the T-CON control circuit board 22 comprises a T-CON control circuit 221, a converting circuit 222 and a first connector 223. The T-CON control circuit 221 connects to the LCD body 21 and connects to the converting circuit 222. The first connector 223 is used to connect the content providing apparatus 23.

Further, the converting circuit 222 is used to convert the video signal from the content providing apparatus 23 to a desired signal to be displayed for the LCD body 21 and transmits the signal to be displayed to the T-CON control circuit 221. The T-CON control circuit 221 drives the LCD body 21 to display images according to received signal to be displayed.

Further, the content providing apparatus 23 may be a smart set-top box such as Baidu box, Tmall box, Mi box and may also be other content providing apparatus. The first connector 233 of the T-CON control circuit board 22 is an HDMI (High Definition Multimedia Interface) for connecting the connector of the content providing apparatus 23, i.e. the content providing apparatus 23 provides video contents to be HD (High Definition) video data.

Continually with reference to FIG. 3, the LCD device 20 further comprises a power circuit board 2 and a backlight driving circuit 25. The back-light driving circuit 25 is a circuit in the backlight module to drive the backlight of the LCD body 21 to be illuminated. The power circuit board 24 comprises a power circuit 241 and a transformer circuit 242. The power circuit 241 is an AC/DC conversion circuit to connect the external power (such as 220V household AC power) for converting the voltage input by the external power such as converting alternating current into direct current, and outputs the converted voltage to the transformer circuit 242. The transformer circuit 252 respectively connects to the T-CON control circuit 221, the first connector 233 and the backlight driving circuit 25.

In addition, in this embodiment, the power for the content providing apparatus 23 is supplied by the LCD device 20 and shares the power circuit 241 with the LCD device 20. Specifically, the transformer circuit 242 supplies power to the T-CON control circuit 221 based on the supplied voltage from the power circuit 241, and supplies power to the content providing apparatus 23 through the first connector 223.

Further, the first connector 223 comprises a working voltage output lead, a standby voltage output lead and an enable signal lead. The transformer circuit 242 outputs the desired working voltage to the content providing apparatus 23 for working normally through the working voltage output lead, and outputs the desired standby voltage to the content providing apparatus 23 for standby through the standby voltage output lead. Thus, the power supplied to the content providing apparatus 23 is achieved. Further, the working voltage output by the working voltage output lead may be 12V or 24V, or any other output voltage. The standby voltage output by the standby voltage output lead may be 5V or any other standby voltage such as 3V or 2V. The output voltages by the working voltage output lead and the standby voltage output lead may be determined according to the model number of the content providing apparatus 23, and is not limited here.

Further, the transformer circuit 242 is also used to transform the voltage supplied by the power circuit 241 to the desired driving voltage for the backlight driving circuit 25 and outputs the driving voltage to the backlight driving circuit 25. Thus, the backlight driving circuit 25 drives the backlight to be illuminated so that the LCD body 21 can display the images.

In addition, the transformer circuit 242 receives the enable signal from the content providing apparatus 23 through the enable signal lead of the first connector 223. When the content providing apparatus 23 is turned on or is switched from the standby status to the working status, an enable signal is transmitted to the LCD device 20 to notify the LCD device 20 to be about to work. The transformer circuit 242 receives the enable signal and provides driving voltage to the backlight driving circuit 25 according to the enable signal so that the backlight driving circuit 25 drives the backlight to be illuminated.

Continually with reference to FIG. 3, the LCD device 20 further comprises at least two signal transmitting circuit board 26. Further, the non-display area around the LCD body 21 bonds the gate driving circuit connecting to the scanning lines of the LCD body and the data driving circuit connecting to the data lines of the LCD body 21. Further, the gate driving circuit specifically is a gate driving IC. The data driving circuit specifically is a data driving IC. The gate driving IC and the data driving IC all use COF (Chip On Film) technic to proceed package. The COF is the technic that uses the flexible circuit board (FPC) as a package carrier to secure the IC on the FPC. As shown in FIG. 3, the FPC to secure the gate driving IC is a gate COF 27. The FPC to secure the data driving IC is a data COF 28. Since the amount of the IC is much more, the amount of the gate COF 27 and the data COF 28 are respectively also more than one. Each gate COF 27 has multiple gate driving IC packaged thereon. Each data COF 28 has multiple data driving IC packaged thereon. Further, the multiple gate COFs 27 are arranged sequentially along a short side of the LCD body 21. The multiple data COFs 28 are arranged sequentially along a longitudinal side of the LCD body 21.

The T-CON control circuit 221 is mainly used to generate the desired control signals respectively for the gate driving ICs and the data driving ICs according to the signal to be displayed. The signal transmitting circuit board 26 has multiple transmitting wires to correspondingly transmit the control signals generated by the T-CON control circuit 221 to the gate driving ICs on the gate COFs 27 and the data driving ICs on the data COFs 28. Further, in this embodiment, the multiple data COFs 28 directly connect to the corresponding signal transmitting circuit boards 26. One signal transmitting circuit board 26 may connect to the data driving ICs on one data COF 28, and may connect to the data driving ICs on the multiple data COFs 28. The multiple gate COFs 27 are not directly connected to the signal transmitting circuit boards 26, but receive the control signals from the T-CON control circuit 221 through the data COFs 28 and the signal transmitting circuit boards 26 in sequence. Specifically, for the multiple data COFs 28 arranged in sequence, the signal transmitting circuit boards 26 connecting to the data COFs 28 at two ends, have one part of the transmitting wires connecting to the data driving ICs on the data COFs 28 to transmit the control signal from the T-CON control circuit 221 to the data driving ICs, and have another part of the transmitting wires connect to the gate driving ICs on the gate COFs 27 through the empty areas on the data COFs 28 to transmit the control signal from the T-CON control circuit board 22 to the gate driving ICs. Then the data driving ICs and the gate driving ICs drive the LCD body 21 to display images according to the received control signals, i.e. the desired control signals of the gate driving ICs are transmitted sequentially through the signal transmitting circuit board 26 and the data COF 28 nearest to the gate COF 27 to the gate driving ICs. The desired control signals of the data driving ICs are directly transmitted from the signal transmitting circuit board 26.

Further, FIG. 3 only shows two signal transmitting circuit board 26, but more signal transmitting circuit board 26 may be mounted according to the size of the LCD body 21 to connect to the data COFs 28 and the T-CON control circuit 221 while actual production.

In this embodiment, the LCD body 21 achieving to display images has following processes: When the LCD device 20 is turned on, the power circuit board 24 respectively supplies power to the T-CON control circuit 221, the content providing apparatus 23 and the transformer circuit 242. The video signal of the content providing apparatus 23 is transmitted to the converting circuit 222 through the first connector 223. The converting circuit 222 converts the video signal of the content providing apparatus 23, such as converting the signal in HDMI format into LVDS and sequence control signal, to retrieve the signal to be displayed that is identifiable by the LCD body 21. The signal to be displayed is transmitted to the T-CON control circuit 221. The T-CON control circuit 221 respectively generates the desired control signals for the gate driving ICs and the data driving ICs according to the signal to be displayed, and the corresponding control signals are transmitted to the gate driving ICs and the data driving ICs through the signal transmitting circuit boards 26 to control the gate driving ICs to output the scanning signal to the LCD body 21 and to control the data driving ICs to output data signals to the LCD body 21. Then the LCD body 21 is driven to display images. More specifically, the desired control signals for the gate driving ICs generating by the T-CON control circuit 221 are transmitted to the gate driving ICs on the gate COFs 27 sequentially through the signal transmitting circuit board 26 and the data COFs 28.

Therefore, by this embodiment, the LCD device 20 does not have the SOC main control circuit board but achieves the images broadcasting through connecting the external content providing apparatus. Thus, the internal structure of the LCD device 20 is optimized and the cost is reduced. In addition, the conventional content providing apparatus is usually supplied power by the external power (220V household power) so that needs to have corresponding power circuit mounted inside. In the present embodiment, the desired working voltage of the content providing apparatus 23 is directly supplied by the LCD device 20. Comparing to the conventional way, the power module can be eliminated from the content providing apparatus 23 to be beneficial to simplify the structure of the content providing apparatus 24 and to lower the manufacturing cost of the content providing apparatus 23.

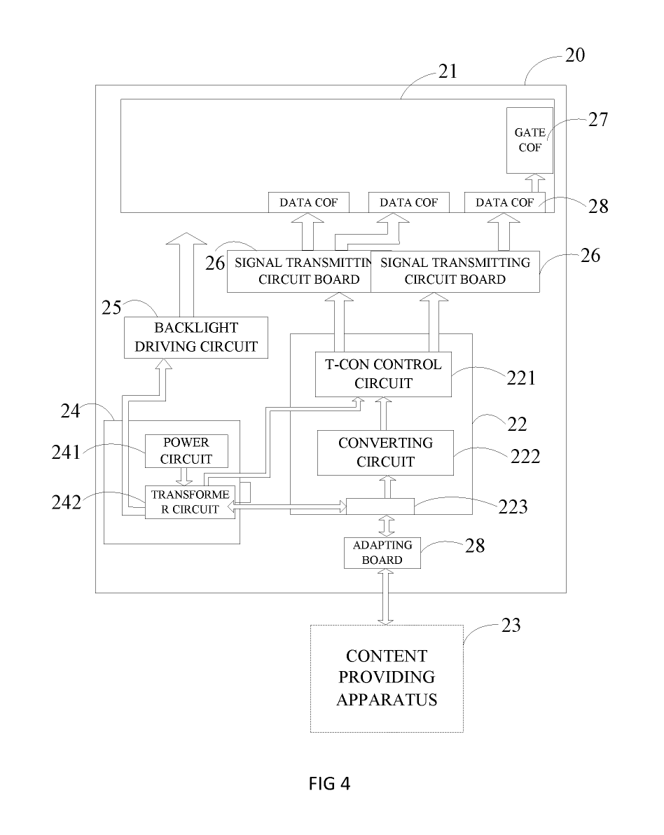

With reference to FIG. 4, FIG. 4 is an illustrative view of still another embodiment of the structure of an LCD device in accordance with the present invention, wherein the components with the same referenced number have the same function. As shown in FIG. 4, in this embodiment, the LCD device 20 further comprises an adapting board 28. The first connector 223 on the T-CON control circuit board 22 connects to the adapting board 28 to connect to the content providing apparatus 23 through the adapting board 28, i.e. the adapting board 28 connects between the first connector 223 and the content providing apparatus 23. Thus, the signals between the content providing apparatus 23 and the LCD device 20 are transmitted through the adapting board 28.

By the operation of the adapting board 28, when different content providing apparatus 23 of different module numbers are used, only needs to change the adapting boards 28 adapting to the leads with the content providing apparatus 23. Then the first connector 223 on the T-CON control circuit board 22, i.e. the circuits on the T-CON control circuit board 22 do not need to be changed. Thus, the same T-CON control circuit board 22 can be adapted to different content providing apparatus 23 to broaden the utilization range.

Moreover, the T-CON control circuit board 22 is located at the middle part of the LCD device 20, and the LCD device 20 is usually placed against the wall or is hung on the wall. If the content providing apparatus 23 is directly connected to the T-CON control circuit board 22, it is not easy for the user to plug or unplug. Further, during the process to plug or unplug, the T-CON control circuit board 22 is easily pulled so that the other circuit boards connecting to the T-CON control circuit board 22 are also pulled to easily damage the circuits. In this embodiment, with the adapting board 28 connecting to the content providing apparatus 23, the adapting board 28 can be mounted on a side of the LCD device 20. The user only needs to plug in or unplug the content providing apparatus 23 from the connector of the adapting board 28 on the side so that it is very easy for user to operate. Furthermore, since the plugging or unplugging is operated to the adapting board 28, the T-CON control circuit board 22 is kept from pulling to effectively protect the internal circuits.

With reference to FIG. 5, in still another embodiment of the LCD device on the present invention, one of the signal transmitting circuit boards 26 and the T-CON control circuit board 22 are assembled on the same circuit board. Specifically, as shown in FIG. 5, the signal transmitting circuit 261 on one of the signal transmitting circuit boards, and the T-CON control circuit 221, the converting circuit 222 and the circuit of the first connector 223 on the T-CON control circuit board 22 are all assembled on the same circuit board 32. Comparing to the conventional way to form two parts of the circuits respectively on two circuit boards, the internal structure of the LCD device 20 is further simplified to reduce the space occupied by the circuit boards and to be beneficial to the development of the LCD device 20 to be lighter and thinner. Moreover, the signal transmitting circuits 261 are transmitting wires.

Certainly, in other embodiments, the multiple signal transmitting circuit boards 26 may be assembled with the T-CON control circuit board 22 on the same circuit board.

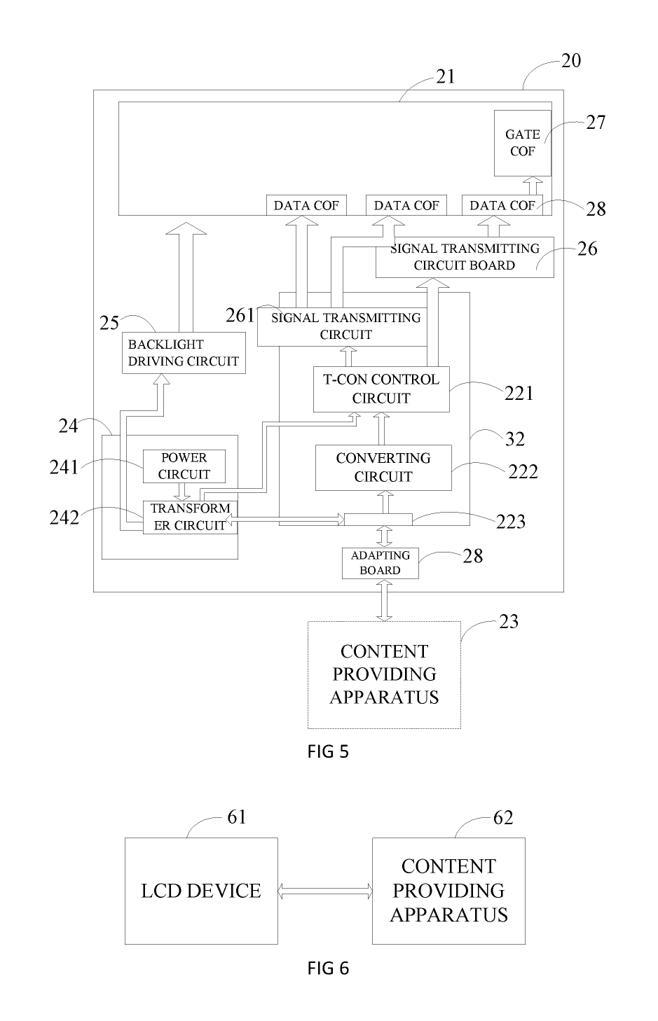

With reference to FIG. 6, in the embodiment of an LCD system in accordance with the present invention, the LCD system comprises an LCD device 61 and a content providing apparatus 62. The content providing apparatus 62 is used to provide the desired video broadcasting content to the LCD device 61. The LCD device 61 has the same structure with any one of the aforementioned embodiments of the LCD device.

Above are embodiments of the present invention, which does not limit the scope of the present invention. Any equivalent structures or equivalent processes utilizing the specification and drawings of the present invention, or directly or indirectly apply to other related technical field should be covered by the protected scope of the invention.

What is claimed is:

1. A liquid crystal display (LCD) device comprising a LCD body, a timer control register (T-CON) control circuit board and an adapting board, wherein:
the T-CON control circuit board connects to the LCD body and is adapted for connecting to an external content providing apparatus; the T-CON control circuit board comprises a converting circuit, a T-CON control circuit and a first connector; the first connector is adapted for connecting to the content providing apparatus; the converting circuit converts a video signal receiving through the first connector from the content providing apparatus to a signal to be displayed for the LCD body, and transmits the signal to be displayed to the T-CON control circuit; the T-CON control circuit drives the LCD body to display images according to the signal to be displayed;
the LCD device does not have a System-On-a-Chip (SOC) main control circuit board; and
the content providing apparatus is a smart set-top box; the first connector is adapted for connecting a high definition multimedia interface (HDMI) of the content providing apparatus; and the first connector connects the converting board to adapted for connecting the content providing apparatus through the converting board.

2. The LCD device according to claim 1 further comprising a power circuit board, wherein the power circuit board comprises a power circuit and a transformer circuit;
the power circuit connects to the transformer circuit; the transformer circuit connects to the T-CON control circuit to supply power to the T-CON control circuit; the transformer circuit also connects to the first connector to adapted for supplying power to the content providing apparatus through the first connector; the transformer circuit also connects to a backlight driving circuit of the LCD body to supply a driving voltage to the backlight driving circuit; and
wherein the first connector comprises:
a working voltage output lead adapted to output a desired working voltage to the content providing apparatus for working normally;
a standby voltage output lead adapted to output a desired standby voltage to the content providing apparatus for standby; and
an enable signal lead adapted to receive an enable signal sending from the content providing apparatus, transmitting the enable signal to the transformer circuit so that the transformer circuit provides driving voltage to the backlight driving circuit of the LCD body.

3. The LCD device according to claim 1 further comprising at least two signal transmitting circuit boards, wherein the T-CON control circuit respectively connects to the at least two signal transmitting circuit boards; the T-CON control circuit generates desired control signals respectively for gate driving circuits and data driving circuits according to the signal to be displayed and correspondingly transmits the control signals to the gate driving circuits and the data driving circuits on the LCD body through the at least two signal transmitting circuit boards to control the gate driving circuits and the data driving circuits to drive the LCD body to display images.

4. The LCD device according to claim 3, wherein at least one of the signal transmitting circuit boards and the T-CON control circuit board are assembled on the same circuit board.

5. An LCD device comprising an LCD body and a T-CON control circuit board, wherein:
the T-CON control circuit board connects to the LCD body and is adapted for connecting to an external content providing apparatus to convert a video signal receiving from the content providing apparatus to a signal to be displayed for the LCD body, drives the LCD body to display images according to the signal to be displayed; and
the LCD device does not have an SOC main control circuit board.

6. The LCD device according to claim 5, wherein the T-CON control circuit board comprises a converting circuit, a T-CON control circuit and a first connector; the first connector is adapted for connecting to the content providing apparatus;
the converting circuit converts the video signal receiving through the first connector from the content providing apparatus to the signal to be displayed for the LCD body, and transmits the signal to be displayed to the T-CON control circuit; and the T-CON control circuit drives the LCD body to display images according to the signal to be displayed.

7. The LCD device according to claim 6, wherein the content providing apparatus is a smart set-top box; the first connector is adapted for connecting an HDMI of the content providing apparatus.

8. The LCD device according to claim 7 further comprising a power circuit board, wherein the power circuit board comprises a power circuit and a transformer circuit;
the power circuit connects to the transformer circuit; the transformer circuit connects to the T-CON control circuit to supply power to the T-CON control circuit; the transformer circuit also connects to the first connector to adapted for supplying power to the content providing apparatus through the first connector; the transformer circuit also connects to a backlight driving circuit of the LCD body to supply a driving voltage to the backlight driving circuit; and
wherein the first connector comprises:
a working voltage output lead adapted to output a desired working voltage to the content providing apparatus for working normally;
a standby voltage output lead adapted to output a desired standby voltage to the content providing apparatus for standby; and
an enable signal lead adapted to receive an enable signal sending from the content providing apparatus, transmitting the enable signal to the transformer circuit so that the transformer circuit provides driving voltage to the backlight driving circuit of the LCD body.

9. The LCD device according to claim 6 further comprising an adapting board, wherein the first connector connects to the adapting board to adapted for connecting to the content providing apparatus through the adapting board.

10. The LCD device according to claim 6 further comprising at least two signal transmitting circuit boards, wherein the T-CON control circuit respectively connects to the at least two signal transmitting circuit boards; the T-CON control circuit generates desired control signals respectively for gate driving circuits and data driving circuits according to the signal to be displayed and correspondingly transmits the control signals to the gate driving circuits and the data driving circuits on the LCD body through the at least two signal transmitting circuit boards to control the gate driving circuits and the data driving circuits to drive the LCD body to display images.

11. The LCD device according to claim 10, wherein at least one of the signal transmitting circuit boards and the T-CON control circuit board are assembled on the same circuit board.

12. An LCD system comprising a content providing apparatus and an LCD device, wherein the LCD device comprises an LCD body and a T-CON control circuit board;
the T-CON control circuit board connects to the LCD body and connects to the external content providing apparatus to convert a video signal receiving from the content providing apparatus to a signal to be displayed for the LCD body, and drives the LCD body to display images according to the signal to be displayed; and
the LCD device does not have an SOC main control circuit board.

13. The LCD system according to claim 12, wherein the T-CON control circuit board comprises a converting circuit, a T-CON control circuit and a first connector; the first connector is adapted for connecting to the content providing apparatus;
the converting circuit converts the video signal receiving through the first connector from the content providing apparatus to the signal to be displayed for the LCD body, and transmits the signal to be displayed to the T-CON control circuit; and the T-CON control circuit drives the LCD body to display images according to the signal to be displayed.

14. The LCD system according to claim 13, wherein the content providing apparatus is a smart set-top box; the first connector is adapted for connecting an HDMI of the content providing apparatus;
the LCD system further comprises a power circuit board, wherein the power circuit board comprises a power circuit and a transformer circuit;
the power circuit connects to the transformer circuit; the transformer circuit connects to the T-CON control circuit to supply power to the T-CON control circuit; the transformer circuit also connects to the first connector to supply power to the content providing apparatus through the first connector; the transformer circuit also connects to a backlight driving circuit of the LCD body to supply a driving voltage to the backlight driving circuit; and
wherein the first connector comprises:
a working voltage output lead to output a desired working voltage to the content providing apparatus for working normally;
a standby voltage output lead to output a desired standby voltage to the content providing apparatus for standby; and
an enable signal lead to receive an enable signal sending from the content providing apparatus, transmitting the enable signal to the transformer circuit so that the transformer circuit provides driving voltage to the backlight driving circuit of the LCD body.

15. The LCD system according to claim 13 further comprising an adapting board, wherein the first connector connects to the adapting board to connect to the content providing apparatus through the adapting board.

16. The LCD system according to claim 13 further comprising at least two signal transmitting circuit boards, wherein the T-CON control circuit respectively connects to the at least two signal transmitting circuit boards; the T-CON control circuit generates desired control signals respectively for gate driving circuits and data driving circuits according to the signal to be displayed and correspondingly transmits the control signals to the gate driving circuits and the data driving circuits on the LCD body through the at least two signal transmitting circuit boards to control the gate driving circuits and the data driving circuits to drive the LCD body to display images.

17. The LCD system according to claim 16, wherein at least one of the signal transmitting circuit boards and the T-CON control circuit board are assembled on the same circuit board.
